(19) United States
(12) Patent Application Publication
(10) Pub. No.: US 2026/0028704 A1
(43) Pub. Date: Jan. 29, 2026

(54) RARE EARTH MAGNET AND METHOD FOR MANUFACTURING THE SAME

(71) Applicant: TOYOTA JIDOSHA KABUSHIKI KAISHA, Toyota-shi (JP)

(72) Inventors: Tetsuya SHOJI, Sunto-gun (JP); Akihito KINOSHITA, Mishima-shi (JP); Noritsugu SAKUMA, Mishima-shi (JP); Hyuga HOSOI, Susono-shi (JP); Hidefumi KISHIMOTO, Susono-shi (JP)

(73) Assignee: TOYOTA JIDOSHA KABUSHIKI KAISHA, Toyota-shi (JP)

(21) Appl. No.: 19/244,667

(22) Filed: Jun. 20, 2025

(30) Foreign Application Priority Data
Jul. 26, 2024 (JP) 2024-121366

(51) Int. Cl. C22C 38/00; B22F 3/14; B22F 3/24; B22F 9/00; B22F 9/04; C22C 38/06; C22C 38/16; H01F 1/057

(52) U.S. Cl. CPC C22C 38/005; B22F 3/14; B22F 3/24; B22F 9/008; C22C 38/002; C22C 38/06; C22C 38/16; H01F 1/0577; B22F 2003/248; B22F 2009/048; B22F 2301/45; B22F 2998/10; B22F 2999/00; C22C 2202/02

(57) ABSTRACT

Provided is a rare earth magnet capable of improving both residual magnetization and coercive force. The rare earth magnet of the present disclosure includes: a main phase; and a grain boundary phase present around the main phase. A total composition in atomic ratio is represented by the formula R¹ₓT_{(100-x-y-z)}(B₍₁₋ₛ₎Cₛ)_{y}M_{z}, R¹ is one or more elements selected from the group consisting of Nd, Ce, La, Pr, Gd, Tb, Dy, and Ho, T is one or more elements selected from the group consisting of Fe, Co, and Ni, M is one or more elements selected from the group consisting of Ga, Al, Cu, Au, Ag, Zn, In, and Mn and unavoidable impurity elements, and 12.0≤x≤20.0, 5.00≤y≤20.0, 0≤z≤2.0, and 0.07≤s≤0.17 are satisfied. The main phase has a crystal structure of R₂Fe₁₄B type, and R is a rare earth element.

### CROSS REFERENCE TO RELATED APPLICATIONS

The present application claims priority from Japanese patent application JP 2024-121366 filed on Jul. 26, 2024, the entire content of which is hereby incorporated by reference into this application.

### BACKGROUND

### Technical Field

The present disclosure relates to a rare earth magnet and a method for manufacturing the same, and more particularly, an R-T-B-based rare earth magnet (where R is a rare earth element, T is a transition metal element, and B is boron) and a method for manufacturing the same.

### Background Art

An R-T-B-based rare earth magnet includes a main phase and a grain boundary phase present around the main phase, and the main phase is a magnetic phase having an R₂Fe₁₄B type crystal structure. High residual magnetization can be obtained by this main phase, and thus the R—T—B-based rare earth magnet is often used for a motor.

In a conventional R—T—B-based rare earth magnet, various attempts have been made to enhance magnetic properties, and a magnet that has been attempted to enhance magnetic property by replacing a part of B (boron) with C (carbon) is known. For example, JP 2002-100524 A discloses an Nd—Fe—B-based magnet manufactured by hot plastic working using 40 weight % or less of powder of disposal materials with the content ratio of carbon being 0.2 weight % or less. Further, JP H05-152119 A discloses an anisotropic permanent magnet containing rare earth elements, iron or mixture of iron with cobalt, carbon, and boron, in which the magnet includes a principal phase of hot-work-aligned, flat, fine grains of tetragonal crystal phase RE₂TM₁₄CₓB₁₋ₓ, wherein RE is one or more of the rare earth elements, TM is iron or mixture of iron with cobalt, and a value of X is from 0.2 to 1.0. Further, J P 2017-157834 A discloses an R—T—B-based permanent magnet containing at least C and Ga, in addition to R, T, and B, and 0.14≤[C]/([B]+[C])≤0.30 is satisfied, where [B] is a B content represented by atom % and [C] is a C content represented by atom %.

### SUMMARY

In the conventional R—T—B-based rare earth magnet in which a part of B is replaced with C, the replacement of the part of B with C can improve the coercive force. However, the replacement of the part of B with C could improve an anisotropy field and decrease a saturation magnetization of a main phase, resulting in the reduced residual magnetization.

The present disclosure has been made in view of such circumstances, and the present disclosure provides a rare earth magnet and a method for manufacturing the same capable of improving both the residual magnetization and the coercive force.

In order to solve the problem, a rare earth magnet of the present disclosure comprises: a main phase; and a grain boundary phase present around the main phase, wherein a total composition in atomic ratio is represented by the formula R¹ₓT_{(100-x-y-z)}(B₍₁₋ₛ₎Cₛ)_{y}M_{z}, R¹ is one or more elements selected from the group consisting of Nd, Ce, La, Pr, Gd, Tb, Dy, and Ho, T is one or more elements selected from the group consisting of Fe, Co, and Ni, M is one or more elements selected from the group consisting of Ga, Al, Cu, Au, Ag, Zn, In, and Mn, and unavoidable impurity elements, and 12.0≤x≤20.0, 5.00≤y≤20.0, 0≤z≤2.0, and 0.07≤s≤0.17 are satisfied. The main phase has a crystal structure of R₂Fe₁₄B type, and R is a rare earth element.

Further, a method for manufacturing the rare earth magnet of the present disclosure is a method for manufacturing the above-described rare earth magnet comprising: preparing a sintered body including a main phase and a grain boundary phase present around the main phase in which a total composition in atomic ratio is represented by the above-described formula R¹ₓT_{(100-x-y-z)}(B₍₁₋ₛ₎Cₛ)_{y}M_{z}, and the main phase has the above-described crystal structure of R₂Fe₁₄B type; and producing an anisotropy-imparted hot plastic-worked body by hot plastic working of the sintered body.

### Effect

According to the present disclosure, both residual magnetization and coercive force can be improved.

### BRIEF DESCRIPTION OF THE DRAWINGS

FIG. 1A is a schematic perspective view illustrating a rare earth magnet according to one embodiment;

FIG. 1B is a schematic view illustrating a cross section of a structure of the rare earth magnet according to the one embodiment;

FIG. 2A is a schematic cross-sectional view of a process illustrating a manufacturing method of the rare earth magnet according to the one embodiment;

FIG. 2B is a schematic cross-sectional view of a process illustrating the manufacturing method of the rare earth magnet according to the one embodiment;

FIG. 2C is a schematic cross-sectional view of a process illustrating the manufacturing method of the rare earth magnet according to the one embodiment;

FIG. 2D is a schematic cross-sectional view of a process illustrating the manufacturing method of the rare earth magnet according to the one embodiment;

FIG. 3A is a graph illustrating changes of ΔBr relative to a ratio s of the atomic ratio of C with respect to the total atomic ratio of B and C, regarding magnets of each group:a group of magnets in which C is added to Nd—Fe—B-based matrix material, a group of magnets in which a part of B is replaced with C in the Nd—Fe—B-based matrix material, and a group of magnets in which a part of B is replaced with C in Nd-reduced matrix material; and

FIG. 3B is a graph illustrating changes of ΔHc relative to a ratio s of the atomic ratio of C with respect to the total atomic ratio of B and C, regarding magnets of each group:a group of magnets in which C is added to Nd—Fe—B-based matrix material, a group of magnets in which a part of B is replaced with C in the Nd—Fe—B-based matrix material, and a group of magnets in which a part of B is replaced with C in Nd-reduced matrix material.

### DETAILED DESCRIPTION

Hereinafter, embodiments of rare earth magnets and methods for manufacturing the same according to the present disclosure will be described.

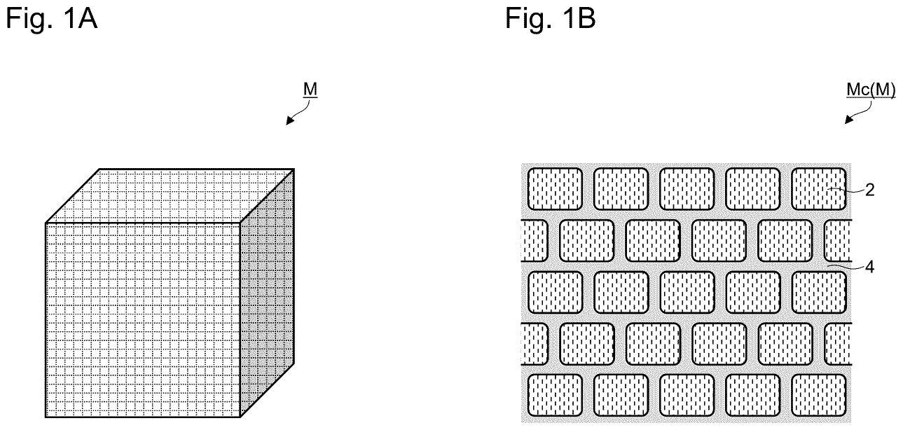

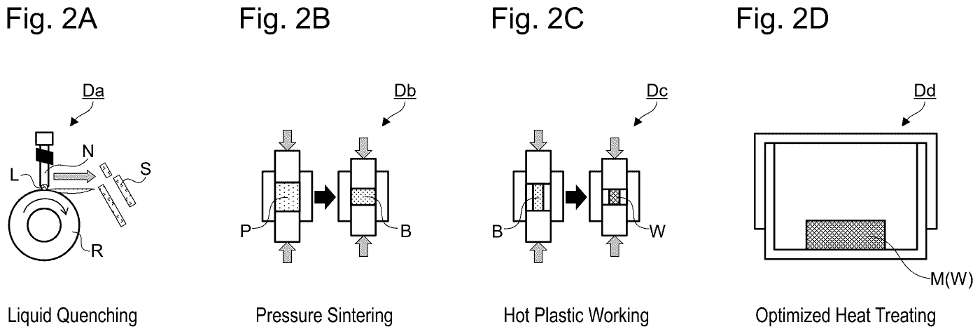

First, a rare earth magnet and a manufacturing method for manufacturing the same according to one embodiment is illustratively described. FIGS. 1A and 1B are each a schematic perspective view illustrating a rare earth magnet and a schematic view illustrating a cross section of a structure of the rare earth magnet according to the one embodiment. FIGS. 2A to 2D are schematic cross-sectional views of processes illustrating the manufacturing method of the rare earth magnet according to the one embodiment.

As illustrated in FIGS. 1A and 1B, as is clear from the cross-sectional structure Mc, a rare earth magnet M according to the one embodiment includes a crystal grain 2 of a main phase and a grain boundary phase 4 present around the crystal grain 2. A total composition of the rare earth magnet M in atomic ratio (mole ratio) [atom %] is represented by a formula R¹ₓT_{(100-x-y-z)}(B₍₁₋ₛ₎Cₛ)_{y}M_{z}. The total composition of the rare earth magnet in atomic ratio herein means the total composition of the whole magnet including the crystal grain of the main phase and the grain boundary phase. R¹ is an essential component and constitutes the main phase (R₂Fe₁₄B phase) together with T and B. R¹ is one or more elements selected from the group consisting of Nd (neodymium), Ce (cerium), La (lanthanum), Pr (praseodymium), Gd (gadolinium), Tb (terbium), Dy (dysprosium), and Ho (holmium). T (transition metal element) is the main component constituting the main phase, and is one or more elements selected from the group consisting of Fe (iron), Co (cobalt), and Ni (nickel). B (boron) constitutes the main phase and gives effect to a proportion of presence of the main phase and the grain boundary phase. C (carbon) replaces a part of B. M is an element containable in the range without impairing magnetic property, and is one or more elements selected from the group consisting of Ga (gallium), Al (aluminum), Cu (copper), Au (gold), Ag (silver), Zn (zinc), In (indium), and Mn (manganese), and unavoidable impurity elements. In this specification (detailed description), unavoidable impurity elements mean impurity elements in raw materials, impurity elements mixed during manufacturing (including elements to be included to the extent that they do not affect magnetic properties), and other impurity elements whose inclusion cannot be avoided or is difficult to avoid due to significant cost increases. Further, 12.0≤x≤20.0, 5.00≤y≤20.0, 0≤z≤2.0, and 0.07≤s≤0.17 are satisfied. Further, x is an atomic ratio of R¹. Further, y is a total atomic ratio of B and C. Further, z is an atomic ratio of M. Further, s is a ratio [-] of the atomic ratio of C with respect to the total atomic ratio of B and C.

The crystal grain 2 (main phase) of the rare earth magnet M is a magnetic phase having a crystal structure of R₂Fe₁₄B type (where R is a rare earth element), which may be simply referred to as “R₂Fe₁₄B phase” herein. The rare earth elements herein include 17 elements, that is, Sc, Y, La, Ce, Pr, Nd, Pm, Sm, Eu, Gd, Tb, Dy, Ho, Er, Tm, Yb, and Lu. The average grain diameter of the crystal grain 2 is less than 1.0 μm.

In a method for manufacturing a rare earth magnet M according to the one embodiment, firstly, molten metal of the alloy whose total composition in atomic ratio is adjusted to the composition represented by the above-described formula R¹ₓT_{(100-x-y-z)}(B₍₁₋ₛ₎Cₛ)_{y}M_{z} is prepared. Then, as illustrated in FIG. 2A, a liquid quenching method is applied and the molten metal L is quenched by spraying the molten metal L from a nozzle N onto the surface of rotating cooling roller R at a liquid quenching device Da to form a magnetic thin strip (quenched ribbon) S.

Then, after obtaining a powder P of magnetic thin pieces by pulverizing the magnetic thin strip S, as illustrated in FIG. 2B, a pressure-sintering is applied to the powder P of the magnetic thin pieces at a high-frequency sintering device Db to form a sintered body B including the crystal grain (main phase) and the grain boundary phase present around the crystal grain. The crystal grain of the sintered body B is a R₂Fe₁₄B phase. Then, as illustrated in FIG. 2C, a hot plastic working is applied to the sintered body B at a pressing device Dc to form an anisotropy-imparted hot plastic-worked body W. Then, as illustrated in FIG. 2D, an optimized heat treating is applied to the hot plastic-worked body W at a heat treating furnace Dd. The rare earth magnet M is manufactured by above-described processes.

In the rare earth magnet M according to the one embodiment, a part of B is replaced with C, and a ratio s of the atomic ratio of C with respect to the total atomic ratio of B and C is equal to or greater than 0.07 and equal to or less than 0.17 (0.07≤s≤0.17). Thus, unlike conventional magnets that differ from the rare earth magnet M in which B is not replaced with C or the ratio s of the atomic ratio of C with respect to the total atomic ratio of B and C is less than 0.07, as the ratio s of the atomic ratio of C with respect to total atomic ratio of B and C is 0.07 or more, the melting point of the grain boundary phase is lowered by C entering the grain boundary phase in the process of forming the sintered body B and thus, its wettability is sufficiently improved. As a result, in the process of forming the anisotropy-imparted hot plastic-worked body W by the hot plastic working process on the sintered body B, when the crystal grains (main phase) attempt to orient themselves such that the axis of easy magnetization direction coincides with the stress direction, accompanied by an anisotropic grain growth in a direction perpendicular to the axis of easy magnetization direction and a grain boundary sliding, the wettability of the grain boundary phase is sufficiently improved, making the progress of orientation of the crystal grains easier. Therefore, the degree of orientation of the crystal grains (main phase) of the hot plastic-worked body W increases, and the degree of orientation of the crystal grains (main phase) of the rare earth magnet M increases. For these reasons and the like, it is possible to improve the residual magnetization of the rare earth magnet M. Further, as the ratio s of the atomic ratio of C with respect to the total atomic ratio of B and C is 0.07 or more, the anisotropy field (anisotropic magnetic field) (Ha) of the main phase is improved and C is also included in the grain boundary phase components, the wettability with the main phase is increased, the grain boundary phase coverage rate of the main phase is improved, a magnetic fragmentation is promoted and the like, thereby the coercive force of the rare earth magnet M can be improved.

On the other hand, unlike the conventional magnets that differ from the rare earth magnet M in which the ratio s of the atomic ratio of C with respect to the total atomic ratio of B and C is greater than 0.17, as the ratio s of the atomic ratio of C with respect to the total atomic ratio of B and C is 0.17 or less, the amount of C contained in the crystal grains (main phase) of the rare earth magnet M is not excessive, and the decrease in saturation magnetization of the crystal grains due to the inclusion of C can be suppressed. Further, since the excessive entry of C into the grain boundary phase of the sintered body B in the process of forming the sintered body B can be avoided, it is possible to suppress segregation of carbon compounds and the like into the grain boundary phase of the rare earth magnet M, which leads to inhomogeneous structure of the grain boundary phase. For these reasons and the like, it is possible to improve the residual magnetization of the rare earth magnet M. Further, since the ratio s of the atomic ratio of C with respect to the total atomic ratio of B and C is 0.17 or less, it is possible to suppress the structure of the grain boundary phase of the rare earth magnet M from being inhomogeneous as described above. For these reasons and the like, the coercive force of the rare earth magnet M can be improved. According to the embodiment, both the residual magnetization and the coercive force can be improved. Next, configurations of the rare earth magnet and the manufacturing method for manufacturing the same according to the embodiment are described in more detail.

The rare earth magnet according to the embodiment is not particularly limited insofar as the rare earth magnet has the main phase and the grain boundary phase present around the main phase, the total composition in atomic ratio [atom %] is represented by the above-described formula R¹ₓT_{(100-x-y-z)}(B₍₁₋ₛ₎Cₛ)_{y}M_{z}, and the main phase is R₂Fe₁₄B-phase.

From the point of view of balancing of magnetic properties and price, one or more elements selected from the group consisting of Nd and Pr may be used as R¹. When the atomic ratio x of R¹ is higher than the atomic ratio of R in the theoretical composition of R₂Fe₁₄B, the main phase can be obtained stably as the R₂Fe₁₄B phase, so a sufficient amount of the R₂Fe₁₄B phase (main phase) can be formed when x is 12.0 or more, and from this point of view, x may be 12.4 or more, 12.8 or more, 13.0 or more, 13.2 or more, 13.4 or more, or 14.0 or more. On the other hand, the grain boundary phase cannot become excessive when x is 20.0 or less, and from this point of view, x may be 19.0 or less, 18.0 or less, 17.0 or less, 16.0 or less, or 15.0 or less. A sufficient amount of the R₂Fe₁₄B phase (main phase) can be formed when the total atomic ratio y of B and C is 5.00 or more, and from this point of view, y may be 5.2 or more, 5.4 or more, 5.5 or more, 5.7 or more, or 5.8 or more. On the other hand, the magnet in which the main phase and the grain boundary phase are present in the correct state can be obtained when y is 20.0 or less, and from this point of view, y may be 18.0 or less, 16.0 or less, 14.0 or less, 12.0 or less, 10.0 or less, 8.0 or less, 6.0 or less, or 5.9 or less. The magnetic property cannot be impaired when the atomic ratio z of M is 2.0 or less, and from this point of view, z may be 1.5 or less, 1.0 or less, 0.65 or less, 0.6 or less, or 0.5 or less.

The residual magnetization can be improved by sufficiently improving the wettability of the grain boundary phase, and the coercive force can also be improved, when the ratio s [-] of the atomic ratio of C with respect to the total atomic ratio of B and C is 0.07 or more. From this point of view, the ratio s may be 0.074 or more, 0.08 or more, 0.10 or more, 0.11 or more, 0.12 or more, 0.13 or more, 0.14 or more, 0.15 or more, or 0.16 or more. On the other hand, the residual magnetization can be improved by suppressing the decrease in the saturation magnetization of the crystal grains (main phase), and the coercive force can be improved by suppressing the structure of the grain boundary phase to be inhomogeneous when the ratio s is 0.17 or less, and from this point of view, the ratio s may be 0.16 or less, 0.15 or less, 0.14 or less, 0.13 or less, 0.12 or less, 0.11 or less, or 0.10 or less.

The main phase of the rare earth magnets may be nanocrystallized. Herein, “main phase is nanocrystallized” means the average grain diameter of the main phase being less than 1.0 μm. If the main phase is nanocrystallized, when the crystal grains (main phase) is oriented for forming the anisotropy-imparted hot plastic-worked body by applying a hot plastic working process to the sintered body to manufacture the rare earth magnets, that orientation of the crystal grains can be easily progressed, and the anisotropy can be easily imparted. From this point of view, the average grain diameter of the main phase may be 0.05 μm or more, 0.10 μm or more, 0.20 μm or more, 0.30 μm or more, 0.40 μm or more, or 0.50 μm or more, or may be 0.90 μm or less, 0.80 μm or less, 0.70 μm or less, or 0.60 μm or less. Herein, “average grain diameter” is measured as follows. In a scanning electron microscope image or a transmission electron microscope image, a certain area is defined as being observed from the direction perpendicular to the axis of easy magnetization, and a plurality of lines are drawn in the direction perpendicular to the axis of easy magnetization for the main phase present within the certain area, and the diameter (length) of the main phase is calculated from the distance between the points where the lines intersect within the grains of the main phase (cutting method). When the cross section of the main phase is close to a circle, it is converted using an equivalent circle diameter of a projected area of the main phase. When the cross section of the main phase is close to a rectangle, it is converted by applying cuboid approximation. The value of D₅₀ of distribution (grain size distribution) of the diameter (length) thus obtained is the average grain diameter.

The grain boundary phase of the rare earth magnets includes phases with unclear crystal structures, such as phases having crystal structures other than the R₂Fe₁₄B type. The term “phase with unclear crystal structure” means a phase, which is not bound by theory, in which at least a part of the phase has an incomplete crystal structure present irregularly or at least a part of the phase has almost no crystalline structure, like noncrystalline.

A Nd-reduced magnet that reduces the use amount of expensive Nd among R¹ and instead uses less expensive elements among R¹ may be employed as the rare earth magnet, and among them, a Nd-reduced magnet in which the atomic ratio [atom %] of Nd with respect to the total of R¹ is 0 or more and 99 or less and the remainder of R¹ contains elements that are less expensive than Nd may be employed, and especially, for example, a Nd-reduced magnet in which R¹ is Nd, Ce, La, and Pr, the atomic ratio [atom %] of Nd with respect to the total of R¹ is 0 or more and 98 or less, the atomic ratio of Ce with respect to the total of R¹ is 1 or more and 99 or less, the atomic ratio of La with respect to the total of R¹ is 1 or more and 99 or less, and the remainder of R¹ is Pr may be employed. This is because, when the atomic ratio of Nd is reduced to below the upper limit of the above-described range, for example, the degree of orientation of the crystal grains (main phase) is likely to decrease, so the improvement action of the degree of orientation by replacing a part of B with C can be more effective. On the other hand, this is because, when the atomic ratio of Nd is increased above the lower limit of the above-described range, for example, and thus the effects due to the reduction of Nd of decreasing the saturation magnetization and the degree of orientation of the crystal grains can be suppressed.

The manufacturing method according to the embodiment is a method for manufacturing the rare earth magnet according to the embodiment, and is not particularly limited insofar as the manufacturing method includes: preparing a sintered body including a main phase and a grain boundary phase present around the main phase in which a total composition in atomic ratio is represented by the formula R¹ₓT_{(100-x-y-z)}(B₍₁₋ₛ₎Cₛ)_{y}M_{z}, which is the same formula as the total composition in atomic ratio of the rare earth magnet according to the embodiment, and the main phase is R₂Fe₁₄B phase; and producing the anisotropy-imparted hot plastic-worked body by hot plastic working of the sintered body.

The process of preparing the sintered body is not particularly limited, and for example, as in the one embodiment, a process of preparing the sintered body including a process of preparing a molten metal of alloy, a process of forming a magnetic thin strip by quenching the molten metal, and a process for forming the sintered body by applying pressure-sintering to the magnetic thin strip or magnetic thin pieces produced by pulverizing the magnetic thin strip is provided.

Normally, the process of preparing the molten metal is a process of preparing the molten metal of alloy whose total composition in atomic ratio is adjusted to the composition represented by a formula R¹ₓT_{(100-x-y-z)}(B₍₁₋ₛ₎Cₛ)_{y}M_{z}, which is the same formula as the total composition in atomic ratio of the rare earth magnet according to the embodiment, however, the process may be a process of preparing the molten metal of alloy in which the composition is adjusted taking into account the amount of consumption for elements that may be consumed in subsequent processes. The process of preparing the molten metal may be, for example, a process of preparing the molten metal by melting an alloy ingot, in some cases, together with additives in an atmosphere such as an inert gas atmosphere (for example, N (nitrogen) gas, Ar (argon) gas).

As the process of quenching the molten metal, for example, a process in which the molten metal is quenched at a rate of 5×10⁵° C./s or more and 5×10⁷° C./s or less may be employed. This is because the magnetic thin strips with a nanocrystallized main phase can be suitably produced. Regarding the process of quenching the molten metal, a process of using the liquid quenching method to quench the molten metal may be employed. An inert gas atmosphere, for example, may be as an atmosphere for the quenching.

The process of subjecting the magnetic thin strips or the magnetic thin pieces to pressure-sintering is not particularly limited insofar as the main phase does not become coarse such that the desired magnetic properties can be obtained, and for example, a process in which the pressure-sintering temperature is set to 470° C. or more and 750° C. or less, the pressure-sintering pressure is set to 50 MPa or more and 600 MPa or less, and the pressure-sintering time is set to 5 minutes or more and 150 minutes or less may be employed. This is because sintered bodies with a nanocrystallized main phase can be obtained suitably. Further, from the point of view of such as suppressing the coarsening of the main phase, a process of cooling the sintered body quickly after the pressure-sintering may be employed. An inert gas atmosphere, for example, may be as an atmosphere for the pressure-sintering.

The process for producing the hot plastic-worked body is not particularly limited insofar as the anisotropy can be imparted to the hot plastic-worked body, and for example, a process in which the temperature of the hot plastic working is set to 740° C. or more and 780° C. or less, the strain rate is set to 0.01/s or more and 1/s or less, and the plastic working rate is set to 50% or more and 80% or less may be employed. This is because the orientation of the crystals in the sintered body can be progressed sufficiently, the anisotropy can be sufficiently imparted to the hot plastic-worked body, and the coarsening of the nanocrystallized main phase can be suppressed. The plastic working rate is calculated as, for example, [(thickness of sample before compression−thickness of sample after compression)×100/thickness of sample before compression] [%]. Further, from the point of view of such as suppressing the coarsening of the main phase, a process of cooling the hot plastic-worked body quickly after the hot plastic working may be employed. An inert gas atmosphere, for example, may be as the atmosphere for the hot plastic working.

As the manufacturing method according to the embodiment, the method may further include a process of optimized heat treating on the hot plastic-worked body. This is because the structure of the magnet, particularly the structure of the grain boundary phase, is arranged such that the residual magnetization and the coercive force can be further improved. As the process, for example, a process of heat-treating on the above-described hot plastic-worked body at a temperature of 500° C. or more and 700° C. or less for a time of 5 minutes or more and 200 minutes or less may be employed. This is because the improvement action becomes significant. Further, from the point of view of such as suppressing the coarsening of the main phase, a process of cooling the hot plastic-worked body quickly after the optimized heat treating may be employed. An inert gas atmosphere, for example, may be as the atmosphere for the heat treating.

### EXAMPLES

Hereinafter, the method for manufacturing the rare earth magnets and the rare earth magnets according to the embodiments will be described in more detail by referring examples and comparative examples.

1. Rare Earth Magnets with Carbon-Added Nd—Fe—B-Based Matrix Material

Hereinafter, examples of rare earth magnets produced by adding C to Nd—Fe—B-based matrix materials (alloy ingots) (Comparative Examples 2 to 4 and Example 1) is described, together with an example of a rare earth magnet in which the Nd—Fe—B-based matrix material is used as it is without addition of C (Comparative Example 1).

### Comparative Example 1

First, certain amounts of Nd, Pr, Ga, Al, Cu, B, and Fe were weighed for a proportion of the weight ratio [weight %] of Nd, Pr, Ga, Al, Cu, B, and Fe to be 29.03:0.4:0.4:0.08:0.1:1.00:balance, and then these certain amounts of Nd, Pr, Ga, Al, Cu, B, and Fe were melted in an arc melting furnace to produce an alloy ingot (Nd—Fe—B-based matrix material). Next, the alloy ingot was melted by high frequency wave in a furnace under a reduced pressure atmosphere of Ar gas, and a molten metal at 1400° C. was obtained.

Then, as illustrated in FIG. 2A, a liquid quenching method was applied and the molten metal was quenched by spraying the molten metal from a nozzle (diameter: 0.6 mm) onto the surface of rotating cooling roller at a liquid quenching device to form a magnetic thin strip (quenched ribbon). At this time, the rolling speed of the cooling roller was set at 25 m/s, and the differential pressure for spraying was set at 25 kPa (nozzle internal pressure: −40 kPa, chamber internal pressure: −65 kPa).

Then, after obtaining a powder of magnetic thin pieces by pulverizing the magnetic thin strip, as illustrated in FIG. 2B, a pressure-sintering was applied to the powder of the magnetic thin pieces at a high-frequency sintering device to form a sintered body. At this time, during the pressure-sintering, a temperature was set at 600° C., a pressure was set at 200 MPa, and a time for pressure-sintering was set at 5 minutes.

Then, as illustrated in FIG. 2C, a hot plastic working was applied to the sintered body at a pressing device to form an anisotropy-imparted hot plastic-worked body. At this time, the sintered body was heated to 750° C., the temperature for the hot plastic working, and then compressed at a plastic working rate of 75% at a strain rate of 0.1/s. Then, as illustrated in FIG. 2D, an optimized heat treating was applied to the hot plastic-worked body at a heat treating furnace. At this time, the hot plastic-worked body was heat-treated for 180 minutes at 580° C. The rare earth magnet was thereby manufactured.

### Comparative Example 2

when obtaining the molten metal used to make the magnetic thin strip, a certain amount of carbon was weighed at a weight ratio of 1.00:0.02 by weight of B in the alloy ingot used in Comparative Example 1 and weight of C in the carbon, and this certain amount of carbon was melted together with the alloy ingot used in Comparative Example 1 in a furnace under a reduced pressure atmosphere of Ar gas by high frequency wave to obtain the molten metal at the same temperature as that of Comparative Example 1. Except for this point, the rare earth magnet was manufactured in the same way as in Comparative Example 1.

### Comparative Example 3

Except that a certain amount of carbon that has been melted together with the alloy ingot was weighed at a weight ratio of 1.00:0.07 by weight of B in the alloy ingot and weight of C in the carbon when obtaining the molten metal used to make the magnetic thin strip, the rare earth magnets were manufactured similar to Comparative Example 2.

### Example 1

Except that a certain amount of carbon that has been melted together with the alloy ingot was weighed at a weight ratio of 1.00:0.1 by weight of B in the alloy ingot and weight of C in the carbon when obtaining the molten metal used to make the magnetic thin strip, the rare earth magnets were manufactured similar to Comparative Example 2.

### Comparative Example 4

Except that a certain amount of carbon that has been melt together with the alloy ingot was weighed at a weight ratio of 1.00:0.25 by weight of B in the alloy ingot and weight of C in the carbon when obtaining the molten metal used to make the magnetic thin strip, the rare earth magnets were manufactured similar to Comparative Example 2.

### [Total Composition, Average Grain Diameter, and Magnetic Property of Magnet]

The total compositions in atomic ratio and the ratios s of the atomic ratios of C with respect to the total atomic ratio of B and C were obtained for the rare earth magnets in Comparative Examples 1 to 3, Example 1, and Comparative Example 4. At this time, each of the contents of Nd, Pr, Ga, Al, Cu, B, and Fe included in the rare earth magnet was measured using ICP emission spectrochemical analysis, the weight ratio of each was determined, the content of C in the rare earth magnet was measured using a carbon/sulfur analyzer (“EMIA-320V2” manufactured by HORIBA, Ltd.), and the weight ratio of C was determined. In addition, these weight ratios were converted to the atomic ratios, and thus the total compositions of the rare earth magnets at atomic ratios were determined. In addition, the ratio s of the atomic ratio of C with respect to the total atomic ratio of B and C at the total composition was obtained. The average grain diameters of the main phases of the magnets in Comparative Examples 1 to 3, Example 1, and Comparative Example 4 were measured using scanning electron microscope images, and were less than 1.0 μm in all cases. Further, the magnetic properties of the rare earth magnets in Comparative Examples 1 to 3, Example 1, and Comparative Example 4 were measured. At this time, a VSM (vibrating sample magnetometer) was used to measure the residual magnetization Br [T] and the coercive force Hc [kA/m], for samples cut from the rare earth magnets, under room temperature. The maximum value of the magnetic field applied during measurement was 1900 kA/m. The results above are shown in Table 1 below. In the following Table 1, the changes in Br and Hc of the magnets for respective examples with respect to Br and Hc of the magnet in Comparative Example 1, in which C was not added, are shown as ΔBr [T] and ΔHc [kA/m], respectively. In the following Table 1, and Tables 2 and 3 to be described later, the atomic ratios [atom %] of respective elements in the total composition are shown rounded off to two decimal places.

TABLE 1

| | | Ratio s [—] in | | | | |
|---|---|---|---|---|---|---|
| | Total Composition of Rare Earth Magnet | Atomic Ratio of C | | | | |
| | in Atomic Ratio [Atom %] | with respect to | | | | |
| | (Atomic ratio [atom %] of each element is indicated | Total Atomic | Br | Hc | ΔBr | ΔHc |
| | to two decimal places.) | Ratio of B and C | [T] | [kA/m] | [T] | [kA/m] |
| Comparative | Nd13.04Pr0.18FebalGa0.37Al0.19Cu0.10B5.99 | 0.0000 | 1.378 | 1398 | 0.000 | 0 |
| Example 1 | | | | | | |
| Comparative | Nd13.03Pr0.18FebalGa0.37Al0.19Cu0.10B5.99C0.13 | 0.0220 | 1.377 | 1402 | −0.001 | 4 |
| Example 2 | | | | | | |
| Comparative | Nd13.00Pr0.18FebalGa0.37Al0.19Cu0.10B5.97C0.40 | 0.0632 | 1.363 | 1403 | −0.015 | 5 |
| Example 3 | | | | | | |
| Example 1 | Nd12.98Pr0.18FebalGa0.37Al0.19Cu0.10B5.97C0.54 | 0.0826 | 1.381 | 1415 | 0.003 | 17 |
| Comparative | Nd12.88Pr0.18FebalGa0.37Al0.19Cu0.10B5.92C1.33 | 0.1837 | 1.404 | 809 | 0.026 | −590 |
| Example 4 | | | | | | |

* Values outside scope of disclosure are underlined.

As shown in Table 1, in the magnet of Example 1 in which the ratio s of the atomic ratio of C with respect to the total atomic ratio of B and C is 0.0826, both Br and Hc were improved without contradiction in comparison with the magnet of Comparative Example 1 that did not contain C. On the other hand, in the magnets of Comparative Examples 2, 3, and 4, either Br or Hc decreased in comparison with the magnet of Comparative Example 1.

2. Rare Earth Magnets in which a Part of B is Replaced with C in Nd—Fe—B-Based Matrix Material

Hereinafter, examples of the rare earth magnets in which a part of B is replaced with C in Nd—Fe—B-based matrix materials (alloy ingots) (Examples 2 to 4 and Comparative Example 6) is described, together with an example of a rare earth magnet in which the Nd—Fe—B-based matrix material is used as it is without replacing B with C (Comparative Example 5).

### Comparative Example 5

First, certain amounts of Nd, Ga, Cu, B, and Fe were weighed for a proportion of the weight ratio [weight %] of Nd, Ga, Cu, B, and Fe to be 30:0.24:0.09:0.97:balance, and then these certain amounts of Nd, Ga, Cu, B, and Fe were melted in an arc melting furnace to produce an alloy ingot (Nd—Fe—B-based matrix material). Next, the alloy ingot was melted by high frequency wave in a furnace under a reduced pressure atmosphere of Ar gas, and a molten metal at 1400° C. was obtained.

Then, as illustrated in FIG. 2A, a liquid quenching method was applied and the molten metal was quenched by spraying the molten metal from a nozzle (diameter: 0.6 mm) onto the surface of rotating cooling roller at a liquid quenching device to form a magnetic thin strip (quenched ribbon). At this time, the rolling speed of the cooling roller was set at 25 m/s, and the differential pressure for spraying was set at 25 kPa (nozzle internal pressure: −40 kPa, chamber internal pressure: −65 kPa).

Then, after obtaining a powder of magnetic thin pieces by pulverizing the magnetic thin strip, as illustrated in FIG. 2B, a pressure-sintering was applied to the powder of the magnetic thin pieces at a high-frequency sintering device to form a sintered body. At this time, during the pressure-sintering, a temperature was set at 600° C., a pressure was set at 200 MPa, and a time for pressure-sintering was set at 5 minutes.

Then, as illustrated in FIG. 2C, a hot plastic working was applied to the sintered body at a pressing device to form an anisotropy-imparted hot plastic-worked body. At this time, the sintered body was heated to 760° C., the temperature for the hot plastic working, and then compressed at a plastic working rate of 65% at a strain rate of 0.1/s. Then, as illustrated in FIG. 2D, an optimized heat treating was applied to the hot plastic-worked body at a heat treating furnace. At this time, the hot plastic-worked body was heat-treated for 60 minutes at 600° C. The rare earth magnet was thereby manufactured.

### Example 2

When the alloy ingot is produced, certain amounts of Nd, Ga, Cu, B, C, and Fe were weighed for a proportion of the weight ratio [weight %] of Nd, Ga, Cu, B, C, and Fe to be 30:0.24:0.09:0.89:0.08:balance, and then these certain amounts of Nd, Ga, Cu, B, C, and Fe were melted in an arc melting furnace to produce an alloy ingot in which a part of B in the alloy ingot used in Comparative Example 5 was replaced with C. Except for this point, the rare earth magnet was manufactured in the same way as in Comparative Example 5.

### Example 3

Except that certain amounts of B and C were weighed for a proportion of the weight ratio [weight %] of B and C to be 0.85:0.12 when the alloy ingot is produced, the rare earth magnets was manufactured in the same way as in Example 2.

### Example 4

Except that certain amounts of B and C were weighed for a proportion of the weight ratio [weight %] of B and C to be 0.80:0.17 when the alloy ingot is produced, the rare earth magnets was manufactured in the same way as in Example 2.

### Comparative Example 6

Except that certain amounts of B and C were weighed for a proportion of the weight ratio [weight %] of B and C to be 0.75:0.22 when the alloy ingot is produced, the rare earth magnets was manufactured in the same way as in Example 2.

### [Total Composition, Average Grain Diameter, and Magnetic Property of Magnet]

The total composition in atomic ratio and the ratios s of the atomic ratio of C with respect to the total atomic ratio of B and C were obtained for the rare earth magnets in Comparative Example 5, Examples 2 to 4, and Comparative Example 6. At this time, each of the contents of Nd, Ga, Cu, B, and Fe included in the rare earth magnet was measured using ICP emission spectrochemical analysis, the weight ratio of each was obtained, the content of C in the rare earth magnets was measured using the above-described carbon/sulfur analyzer, and the weight ratio of C was obtained. In addition, these weight ratios were converted to the atomic ratios, and thus the total compositions of the rare earth magnets at the atomic ratios was obtained. In addition, the ratio s of the atomic ratio of C with respect to the total atomic ratio of B and C at the total composition was obtained. The average grain diameters of the main phases of the magnets in Comparative Example 5, Examples 2 to 4, and Comparative Example 6 were measured using scanning electron microscope images, and were less than 1.0 μm in all cases. Further, the magnetic properties of the rare earth magnets in Comparative Example 5, Examples 2 to 4, and Comparative Example 6 were measured. At this time, the residual magnetization Br and the coercive force Hc were measured in the same way as above. The results above are shown in Table 2 below. In the following Table 2, the changes in Br and Hc of the magnets for respective examples with respect to Br and Hc of the magnets in Comparative Example 5, in which B was not replaced with C, are shown as ΔBr and ΔHc, respectively.

TABLE 2

| | | Ratio s [—] in | | | | |
|---|---|---|---|---|---|---|
| | Total Composition of Rare Earth Magnet | Atomic Ratio of C | | | | |
| | in Atomic Ratio [Atom %] | with respect to | | | | |
| | (Atomic ratio [atom %] of each element is | Total Atomic | Br | Hc | ΔBr | ΔHc |
| | indicated to two decimal places.) | Ratio of B and C | [T] | [kA/m] | [T] | [kA/m] |
| Comparative | Nd13.60FebalGa0.22Cu0.09B5.85 | 0.0000 | 1.360 | 1279 | 0.000 | 0 |
| Example 5 | | | | | | |
| Example 2 | Nd13.30FebalGa0.22Cu0.09B5.37C0.43 | 0.0749 | 1.383 | 1382 | 0.023 | 103 |
| Example 3 | Nd13.50FebalGa0.23Cu0.09B5.13C0.65 | 0.1127 | 1.374 | 1321 | 0.014 | 42 |
| Example 4 | Nd13.59FebalGa0.22Cu0.09B4.83C0.92 | 0.1606 | 1.363 | 1299 | 0.003 | 21 |
| Comparative | Nd13.42FebalGa0.22Cu0.09B4.53C1.20 | 0.2089 | 1.338 | 1129 | −0.022 | −150 |
| Example 6 | | | | | | |

* Values outside scope of disclosure are underlined.

As shown in Table 2, in the magnets of Example 2 to 4 in which the ratio s of the atomic ratio of C with respect to the total atomic ratio of B and C is 0.0749 to 0.1606, both Br and Hc were improved without contradiction in comparison with the magnet of Comparative Example 5 in which B was not replaced with C. On the other hand, in the magnet of Comparative Example 6, both Br and Hc decreased in comparison with the magnet of Comparative Example 5.

3. Rare Earth Magnets in which a Part of B is Replaced with C in Nd-Reduced Matrix Material

Hereinafter, examples of rare earth magnets in which a part of B is replaced with C in Nd-reduced matrix material (alloy ingots), which is Nd—Fe—B-based matrix material, reduces the use amount of expensive Nd, and uses less expensive Pr, La, and Ce instead (Example 5 and Comparative Example 8) is described together with an example of a rare earth magnet in which the Nd-reduced matrix material is used as it is without replacing B with C (Comparative Example 7).

### Comparative Example 7

First, certain amounts of Nd, Ce, La, Pr, Co, Ga, Cu, B and Fe were weighed for a proportion of the weight ratio [weight %] of Nd, Ce, La, Pr, Co, Ga, Cu, B and Fe to be 21.85:0.48:1.0:7.25:1.0:0.38:0.1:0.93:balance, and then these certain amounts of Nd, Ce, La, Pr, Co, Ga, Cu, B and Fe were melted in an arc melting furnace to produce an alloy ingot (Nd-reduced matrix material). Next, the alloy ingot was melted by high frequency wave in a furnace under a reduced pressure atmosphere of Ar gas, and a molten metal at 1400° C. was obtained.

Then, as illustrated in FIG. 2A, a liquid quenching method was applied and the molten metal was quenched by spraying the molten metal from a nozzle (diameter: 0.6 mm) onto the surface of rotating cooling roller at a liquid quenching device to form a magnetic thin strip (quenched ribbon). At this time, the rolling speed of the cooling roller was set at 25 m/s, and the differential pressure for spraying was set at 25 kPa (nozzle internal pressure: −40 kPa, chamber internal pressure: −65 kPa).

Then, after obtaining a powder of magnetic thin pieces by pulverizing the magnetic thin strip, as illustrated in FIG. 2B, a pressure-sintering was applied to the powder of the magnetic thin pieces at a high-frequency sintering device to form a sintered body. At this time, during the pressure-sintering, a temperature was set at 600° C., a pressure was set at 200 MPa, and a time for pressure-sintering was set at 5 minutes.

Then, as illustrated in FIG. 2C, a hot plastic working was applied to the sintered body at a pressing device to form an anisotropy-imparted hot plastic-worked body. At this time, the sintered body was heated to 760° C., the temperature for the hot plastic working, and then compressed at a plastic working rate of 65% at a strain rate of 0.1/s. Then, as illustrated in FIG. 2D, an optimized heat treating was applied to the hot plastic-worked body at a heat treating furnace. At this time, the hot plastic-worked body was heat-treated for 60 minutes at 650° C. The rare earth magnet was thereby manufactured.

### Example 5

When the alloy ingot is produced, certain amounts of Nd, Ce, La, Pr, Co, Ga, Cu, B, C, and Fe were weighed for a proportion of the weight ratio [weight %] of Nd, Ce, La, Pr, Co, Ga, Cu, B, C, and Fe to be 21.85:0.48:1.0:7.25:1.0:0.38:0.1:0.82:0.11:balance, and then these certain amounts of Nd, Ce, La, Pr, Co, Ga, Cu, B, C, and Fe were melted in an arc melting furnace to produce an alloy ingot in which a part of B in the alloy ingot used in Comparative Example 7 was replaced with C. Except for this point, the rare earth magnet was manufactured in the same way as in Comparative Example 7.

### Comparative Example 8

Except that certain amounts of B and C were weighed for a proportion of the weight ratio [weight %] of B and C to be 0.72:0.21 when an alloy ingot is produced, the rare earth magnet was manufactured in the same way as in Example 5.

### [Total Composition, Average Grain Diameter, and Magnetic Property of Magnet]

The total compositions in atomic ratio and the ratios s of the atomic ratio of C with respect to the total atomic ratio of B and C were obtained for the rare earth magnets in Comparative Example 7, Example 5, and Comparative Example 8. At this time, each of the content of Nd, Ce, La, Pr, Co, Ga, Cu, B, and Fe included in the rare earth magnet was measured using ICP emission spectrochemical analysis, the weight ratio of each was determined, the content of C in the rare earth magnets was measured using the above-described carbon/sulfur analyzer, and the weight ratio of C was obtained. In addition, these weight ratios were converted to the atomic ratios, and thus the total compositions of the rare earth magnets at atomic ratio were obtained. In addition, the ratio s of the atomic ratio of C with respect to the total atomic ratio of B and C at the total composition was determined. The average grain diameters of the main phases of the magnets in Comparative Example 7, Example 5, and Comparative Example 8 were measured using scanning electron microscope images, and were less than 1.0 μm in all cases. Further, the magnetic properties of the rare earth magnets in Comparative Example 7, Example 5, and Comparative Example 8 were measured. At this time, the residual magnetization Br and the coercive force Hc were measured in the same way as above. The results above are shown in Table 3 below. In the following Table 3, the changes in Br and Hc of the magnets for respective examples with respect to Br and Hc of the magnet in Comparative Example 7, in which B was not replaced with C, are shown as ΔBr and ΔHc, respectively.

TABLE 3

| | | Ratio s [—] in | | | | |
|---|---|---|---|---|---|---|
| | Total Composition of Rare Earth Magnet | Atomic Ratio of C | | | | |
| | in Atomic Ratio [Atom %] | with respect to | | | | |
| | (Atomic ratio [atom %] of each element is | Total Atomic | Br | Hc | ΔBr | ΔHc |
| | indicated to two decimal places.) | Ratio of B and C | [T] | [kA/m] | [T] | [kA/m] |
| Comparative | Nd9.90Ce0.22La0.47Pr3.30FebalCo1.10Ga0.36Cu0.10B5.64 | 0.0000 | 1.270 | 1373 | 0.000 | 0 |
| Example 7 | | | | | | |
| Example 5 | Nd9.90Ce0.22La0.47Pr3.30FebalCo1.10Ga0.36Cu0.10B4.97C0.60 | 0.1077 | 1.327 | 1454 | 0.056 | 80 |
| Comparative | Nd9.90Ce0.22La0.47Pr3.30FebalCo1.10Ga0.36Cu0.10B4.37C1.15 | 0.2079 | 1.360 | 1186 | 0.089 | −187 |
| Example 8 | | | | | | |

* Values outside scope of disclosure are underlined.

As shown in Table 3, in the magnet of Example 5 in which the ratio s of the atomic ratio of C with respect to the total atomic ratio of B and C is 0.1077, both Br and Hc were improved without contradiction in comparison with the magnet of Comparative Example 7 in which B was not replaced with C. On the other hand, in the magnet of Comparative Example 8, the Hc decreased in comparison with the magnet of Comparative Example 7.

### 4. Evaluation

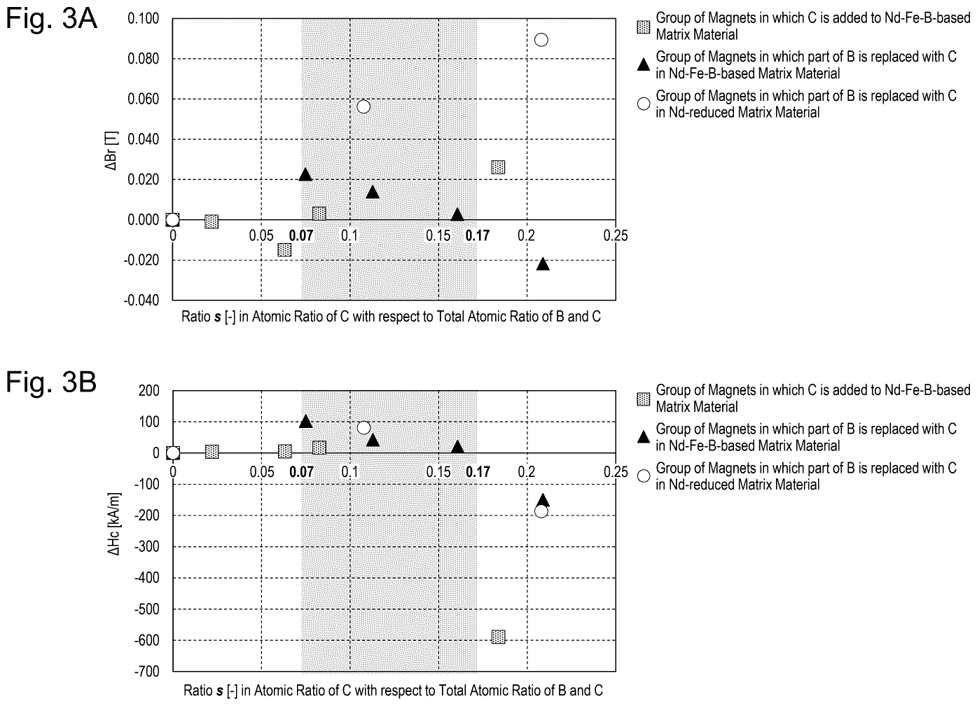

FIG. 3A is a graph illustrating changes of ΔBr relative to the ratio s of the atomic ratio of C with respect to the total atomic ratio of B and C, regarding magnets of each group:a group of magnets in which C is added to Nd—Fe—B-based matrix material (magnets of Comparative Examples 1 to 3, Example 1, and Comparative Example 4), a group of magnets in which a part of B is replaced with C in the Nd—Fe—B-based matrix material (magnets of Comparative Example 5, Examples 2 to 4, and Comparative Example 6), and a group of magnets in which a part of B is replaced with C in Nd-reduced matrix material (magnets of Comparative Example 7, Example 5, and Comparative Example 8). On the other hand, FIG. 3B is a graph illustrating changes of ΔHc relative to the ratio s of the atomic ratio of C with respect to the total atomic ratio of B and C, regarding magnets of each group:a group of magnets in which C is added to Nd—Fe—B-based matrix material, a group of magnets in which a part of B is replaced with C in the Nd—Fe—B-based matrix material, and a group of magnets in which a part of B is replaced with C in Nd-reduced matrix material.

As obvious from FIGS. 3A and 3B, and Tables 1 to Table 3, in the magnets in which the ratios s of the atomic ratios of C with respect to the total atomic ratio of B and C is 0.07 or more and 0.17 or less, both Br and Hc were thought to be improved without contradiction in comparison with the magnet in which the ratio s of the atomic ratio of C with respect to the total atomic ratio of B and C is 0.00. Further, in the group of magnets in which a part of B is replaced with C in the Nd-reduced matrix material, an optimal value of the ratio s of the atomic ratio of C with respect to the total atomic ratio of B and C is thought to exist, where both Br and Hc are improved without contradiction, similar to the other groups.

The embodiments of the rare earth magnet and the method for manufacturing the same according to the present disclosure have been described in detail, however, the present disclosure is not limited thereto, and can be subject to various design changes without departing from the spirit of the present disclosure described in the claims.

### DESCRIPTION OF SYMBOLS

M Rare earth magnet
2 Crystal grain (main phase)
4 Grain boundary phase
B Sintered body
W Hot plastic-worked body

What is claimed is:

1. A rare earth magnet comprising:
a main phase; and
a grain boundary phase present around the main phase,
wherein a total composition in atomic ratio is represented by the formula R¹ₓT_{(100-x-y-z)}(B₍₁₋ₛ₎Cₛ)_{y}M_{z}, R¹ is one or more elements selected from the group consisting of Nd, Ce, La, Pr, Gd, Tb, Dy, and Ho, T is one or more elements selected from the group consisting of Fe, Co, and Ni, M is one or more elements selected from the group consisting of Ga, Al, Cu, Au, Ag, Zn, In, and Mn, and unavoidable impurity elements, and 12.0≤x≤20.0, 5.00≤y≤20.0, 0≤z≤2.0, and 0.07≤s≤0.17 are satisfied, and
wherein the main phase has a crystal structure of R₂Fe₁₄B type, and R is a rare earth element.

2. The rare earth magnet according to claim 1,
wherein an average grain diameter of the main phase is less than 1.0 μm.

3. A method for manufacturing the rare earth magnet according to claim 1, comprising
preparing a sintered body including a main phase and a grain boundary phase present around the main phase in which a total composition in atomic ratio is represented by the formula R¹ₓT_{(100-x-y-z)}(B₍₁₋ₛ₎Cₛ)_{y}M_{z}, R¹ is one or more elements selected from the group consisting of Nd, Ce, La, Pr, Gd, Tb, Dy, and Ho, T is one or more elements selected from the group consisting of Fe, Co, and Ni, M is one or more elements selected from the group consisting of Ga, Al, Cu, Au, Ag, Zn, In, and Mn, and unavoidable impurity elements, 12.0≤x≤20.0, 5.00≤y≤20.0, 0≤z≤2.0, and 0.07≤s≤0.17 is satisfied, the main phase has a crystal structure of R₂Fe₁₄B type, and R is a rare earth element; and
producing an anisotropy-imparted hot plastic-worked body by hot plastic working of the sintered body.

4. The method for manufacturing the rare earth magnet according to claim 3, further comprising
in the producing, setting a temperature of the hot plastic working to 740° C. or more and 780° C. or less, setting a strain rate to 0.01/s or more and 1/s or less, and setting a plastic working rate to 50% or more and 80% or less.

5. The method for manufacturing the rare earth magnet according to claim 3, further comprising
heat-treating the hot plastic-worked body at a temperature of 500° C. or more and 700° C. or less for a time of 5 minutes or more and 200 minutes or less.
